(19) United States
(12) Patent Application Publication
(10) Pub. No.: US 2004/0115099 A1
(43) Pub. Date: Jun. 17, 2004

(54) Reagent vial for automated processing apparatus

(76) Inventor: James C. Smith, Hayward, CA (US)

Correspondence Address: The Law Offices of James C. Weseman, Suite 1600, 401 West A Street, San Dieg, CA, 92101, US

(21) Appl. No.: 10/659,767

(22) Filed: Sep. 9, 2003

Related U.S. Application Data
(63) Continuation of application No. 09/744,092, filed on Jul. 9, 2001, now abandoned.
Application No. 09/744,092 is a 371 of international application No. PCT/US99/11823, filed on May 27, 1999.

(51) Int. Cl. B01L 3/00

(52) U.S. Cl. 422/102

(57) ABSTRACT

The present invention provides a reagent vial designed for use with automated processing devices. In one aspect, the present reagent vial comprises a container portion configured to contain a volume of liquid reagent, and having an upper end and a lower end. The upper end of the container portion is configured to provide access to the contents of the container portion by a probe, typically of a type used by an automated processing apparatus to withdraw the liquid reagent therein contained. The lower end of the container portion is configured to provide a chamber aligned with the probe access, and having a lesser cross sectional area than the main container portion. The chamber is thus configured to contain a portion of the volume of liquid reagent of the container to provide a means for reducing the residual volume of reagent which can not be withdrawn from the vial by the probe. Other aspect of the invention include an adapter for positioning the reagent vial, and a system employing the reagent vial and the adapter in cooperation.

### TECHNICAL FIELD

The present invention relates to reagent containers and, more particularly, to reagent containers for use with automated processing devices such as immunostainers.

### BACKGROUND OF THE INVENTION

Hospitals and clinical laboratories perform many clinical chemical analyses and diagnostics tests on body fluids and tissue specimens, in order to identify the presence or determine the levels of various markers or constituent components. Such tests and analyses tend to be both labor intensive and repetitive.

For example, microscopic examination of unstained cell and tissue specimens often suffers from a lack of contrast between individual cells and the background matrix or between individual parts of cells. In order to alleviate this difficulty, stains that are taken up differentially by cells or parts of cells have been used for over a century.

Because of the manner in which microscope slides with tissue samples are prepared (see Elias, J., “Immunohistopathology: A practical Approach to Diagnosis” ASCO Press, 1990, pp. 3-4, for examples of such preparation), the size and/or location of a tissue sample on a microscope slide can vary considerably within a relatively large area of the slide. In order to apply a stain to the correct location on a slide and to provide rinsing and other manipulation steps at appropriate times and in proper amounts, until recently all such staining operations were carried out by hand. However, modern immunostaining techniques often require multi-step staining techniques, and laboratories that examine large numbers of tissue specimens or conduct other diagnostic tests find it desirable to automate the staining or diagnostic processes. Accordingly, a number of manufacturers have developed equipment for automated staining of tissue samples on slides, as well as devices which automate other aspects of diagnostic procedures utilizing various reagents.

For example, U.S. Pat. No. 4,985,206 describes an apparatus and process for automating the application of staining reagents to a thin tissue section mounted on a microscope slide. The apparatus and method use a channel-defining element that is assembled with the microscope slide to provide an enclosure of capillary dimensions into which liquids can be injected. Liquids are added sequentially to the capillary space, where the addition of a new liquid forces out the previous liquid. A plurality of these assemblies of microscope slides and specialized covers can be placed in a rack on an apparatus for automated addition of liquids.

A further automated immunostaining apparatus, known as the Ventana 320™ is produced by Ventana Medical Systems, Inc. This apparatus applies a liquid known as Liquid Coverslip™ to each slide prior to reagent addition. Liquid Coverslip™ is a non-aqueous material having a density less than that of water. When a reagent dissolved in water is added to a microscope slide, the reagent sinks to the bottom of the Liquid Coverslip™ layer, spreading across the surface of the slide. Slides are organized on a carousel which rotates beneath a dispensing head of the apparatus for application of reagents or wash fluids.

Yet another apparatus, known as the Jung Histostainer Ig™ Automated Immunostainer, is produced by Leica Instrument GmbH. This is also a carousel-type device, but reagents are applied by a spraying operation rather than by dropping liquid onto an organic film. The apparatus contains a permanent reagent spraying head that can be moved along a single axis to provide spray coverage over a microscope slide located on the rotating tray when the slide is rotated into position underneath the head. Excess reagent is removed by a permanent clearing nozzle which blows air in a pressure front across the slide, forcing excess liquid off at the completion of the reagent incubation step.

A further apparatus is the subject of U.S. Pat. No. 5,439,649. This device includes an arm moveable in three dimensions attached to a framework. A hollow tip head is carried on the arm, and includes a wash/blow head for dispensing reagents and clearing the slides. The reagent application tip can be attached to the hollow tip head or removed by a pre-selected movement of the arm.

All of these devices attempt to solve certain conflicting goals in automated apparatuses of this type. For example, it is desirable to minimize the use of expensive or toxic reagents, particularly reagents used in immunostaining (e.g. antibodies and other reagents of biological origin). However, the design of the vials used to store the reagents for use in the automated devices typically suffer from a number of design limitations which can effect the ability of a device, particularly one which utilizes a pipette-type tip for application of reagents, to use the residual reagent in the container, as well as ensure that the device can reliably and accurately meter the reagent withdrawn from the container to effectively control costs. The spraying operation in the penultimate-referenced device above typically uses an excess of reagent, which contributes to increased cost of operation. While the later referenced device of U.S. Pat. No. 5,439,649 addresses this problem, it has heretofore be difficult to ensure that the device can reliably utilize all of the reagent contained in the storage containers. Thus, additional manipulative steps have been required, such as refilling the storage containers to a safe level during the operation of the device.

Thus, it is considered desirable to provide a reagent container which is designed to be used in conjunction with an automated apparatus that can permit the device to reliably and accurately meter the reagent withdrawn from the container, while allowing the device to use virtually all of the residual reagent in the container.

### DISCLOSURE OF THE INVENTION

The present invention provides a reagent vial designed for use with automated processing devices. In one aspect, the present reagent vial comprises a container portion configured to contain a volume of liquid reagent, and having an upper end and a lower end. The upper end of the container portion is configured to provide access to the contents of the container portion by a probe, typically of a type used by an automated processing apparatus to withdraw the liquid reagent therein contained. The lower end of the container portion is configured to provide a chamber aligned with the probe access, and having a lesser cross sectional area than the main container portion. The chamber is thus configured to contain a portion of the volume of liquid reagent of the container to provide a means for reducing the residual volume of reagent which can not be withdrawn from the vial by the probe.

In a further aspect, the vial of the present invention will be used in conjunction with an adapter assembly which is configured to provide a receptacle for holding a reagent vial according to the invention, and further configured to fit into the available receptacle in an automated processing apparatus.

A still further aspect of the invention provides a system employing the reagent vial and the adapter assembly in a cooperative relationship.

### BRIEF DESCRIPTION OF THE DRAWINGS

FIG. 1 depicts an embodiment of the reagent vial of the present invention, wherein FIG. 1A is a side elevation thereof, FIG. 1B is an end view elevation thereof, FIG. 1C is cross sectional side view thereof, FIG. 1D is an cross sectional end view thereof, FIG. 1E is a top plan view thereof, and FIG. 1F is a bottom plan view thereof;

FIG. 2 depicts an alternative embodiment of the reagent vial of the present invention, wherein FIG. 2A is a side elevation thereof, FIG. 2B is an end view elevation thereof, FIG. 2C is cross sectional side view thereof, FIG. 2D is an cross sectional end view thereof, FIG. 2E is a top plan view thereof, and FIG. 2F is a bottom plan view thereof;

FIG. 3 depicts an embodiment of an adapter assembly for the reagent vial of FIG. 2 of the present invention, wherein FIG. 3A is a side elevation thereof, FIG. 3B is an end view elevation thereof, FIG. 3C is cross sectional side view thereof, FIG. 3D is an cross sectional end view thereof, FIG. 3E is a top plan view thereof, and FIG. 4F is a bottom plan view thereof; and

FIG. 4 depicts the operation of a typical automated processing apparatus utilizing the reagent vial of the present invention.

### DETAILED DESCRIPTION OF THE INVENTION

The present invention provides a reagent vial primarily designed for use with automated processing apparatus. In one aspect, the present reagent vial comprises a container portion configured to contain a volume of liquid reagent, and having an upper end and a lower end. The upper end of the container portion is configured to provide access to the contents of the container portion by a probe, typically of a type used by an automated processing apparatus to withdraw the liquid reagent therein contained. The lower end of the container portion is configured to provide a chamber aligned with the probe access, and having a lesser cross sectional area than the main container portion. The chamber is thus configured to contain a portion of the volume of liquid reagent of the container to provide a means for reducing the residual volume of reagent which can not be withdrawn from the vial by the probe.

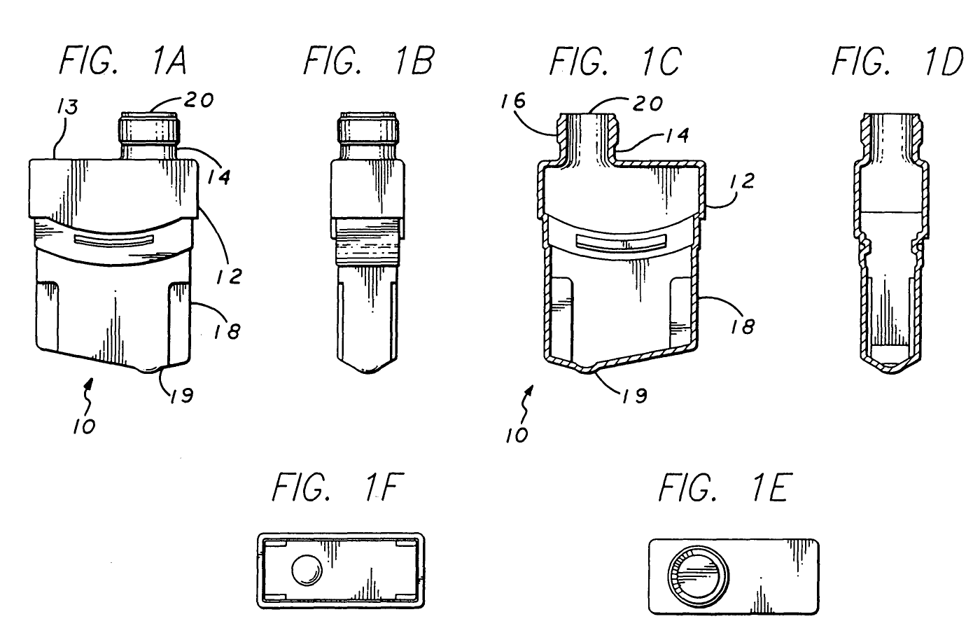

One embodiment of the reagent vial of the present invention is identified generally by the numeral 10 in FIG. 1. The reagent vial 10 may be constructed in accordance with known techniques, desirably blow molded or injection molded from a suitable plastic material. Alternatively, the reagent vial could be formed of glass or other suitable material. Generally, the reagent vial will be formed from glass for storing reagents which may be susceptible to the intrusion of moisture that conceivably could migrate through certain plastics.

The vial 10 comprises a container portion 12 which is intended to contain the major share of the reagent, typically the vial will be supplied in predetermined convenient volumes such as 10 mL, 12 mL, 20 mL, and the like.

The present vial 10 is generally configured for placement and use in an appropriate automated processing apparatus for clinical testing or analysis, such as the OptiMax® automated immnunostainer apparatus (BioGenex Laboratories, San Ramon, Calif.), which is an embodiment of U.S. Pat. No. 5,439,649, the entire contents of which are incorporated herein by this reference. In this apparatus, reagent vials are positioned in a reagent vial rack which is either affixed to the apparatus or removable from the apparatus for loading the reagent vials in a more convenient location. The rack in this apparatus contains a number of separate receptacles of generally rectangular cross section, to facilitate the efficient storage of a plurality of vials. Thus, the present embodiment of vial 10 is depicted with container portion 12 having a complimentary rectangular horizontal cross section, the container having four substantially planar sidewalls, although numerous other shapes are possible to accommodate different racks, or other applications.

The container portion 12 will have an upper surface 13 which will approximate the cross sectional shape of the container portion, in this embodiment rectangular. Upper surface 13 will include an opening 14 defining a neck extending upwardly from vial 10. The opening neck 14 is generally characterized by an array of external threads 16 formed thereon. The opening 14 permits the addition of an appropriate reagent or reagent diluent, such as water, sterile water, saline, phosphate buffered saline, TRIS or TWEEN® buffers or the like, into the reagent container 12, as well as the withdrawal of desired amounts of the liquid reagent contained in the vial.

The opening neck 14 of the present reagent vial 10 will typically be located off-center in the upper surface 13 of the present vial 10, in order to provide a shoulder region which is available for labeling with relevant information regarding the contents of the vial and the like. Typically such labeling will be accomplished either in human-readable printed form or by machine-readable bar-code, or both. In the bar-code technology format, typically three bar-codes are printed in close proximity to each other on the label. The information content of the bar-code can include: 1) Name of the reagent solution; 2) Manufacture date; 3) Expiration date; 4) Serial number; 5) Reagent volume. The height of the bar-code is generally approximately 0.25 inch, so that there will remain sufficient space for the user to write any other desired information. The coding used in this application will desirably be code128, as this code can provide advantageous information density. A human-readable string is desirably also printed on the label and is shown on the side wall of the reagent vial.

In addition, in apparatus such as the aforementioned OptiMax® automated immunostainer, there will usually be a pre-printed label applied to a region on the upper surface of the microscope slide. This label is intended for the user to include certain information. The content of this bar-code will include the name of the protocol to be used in processing the particular slide. A human-readable string can also be printed immediately under this bar-code as well. The availability of a bar code label will provide a machine readable function which can be integrated with the programmed instruction set of the automated processing apparatus and thereby provide a more efficient means of identifying and verifying the contents of the vial and its appropriate use in the pre-programmed instruction set sequence of the apparatus.

Typically, such assembly and labeling will be performed by the manufacturer of the reagent at the place of manufacture and subsequently shipped to the appropriate facility, such as a clinical chemical laboratory or reference laboratory and readied for use. Generally, the manufacture of the reagent will also dispose an appropriate color code on the reagent vial to identify the particular reagent stored therein. The same manufacturer of the reagent may also provide an appropriate adapter assembly to facilitate storage and use of the reagent vial. Also desirable could be an optional removable seal over the opening neck of the reagent vial. Alternatively, the reagent buffer or reagent can be placed in the reagent vial container by the appropriate personnel in the clinical chemical laboratory.

In the OptiMax® automated immunostainer example, before initiating an operation, the apparatus moves a laser bar-code scanner around the bar-codes located both on the microscope slides and the reagent vials. The digital computer will then recognize the reagents and the slides to be treated, and will calculate the required volumes of the reagents. A reagent map can also be printed by the computer for user reference. If any deficiency occurs in the reagent supply, the computer will halt the processing and request additional reagent supplies.

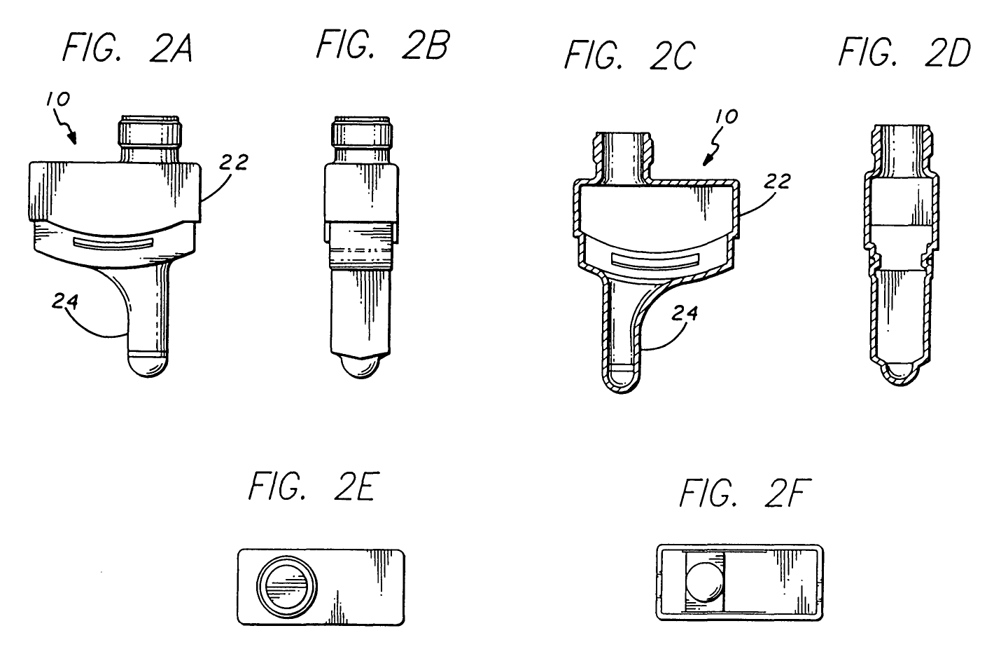

The reagent vial 10 shown in FIG. 1 further comprises a lower end 18 which can be formed as an integral part of the blow molded container portion. This lower end 18 of the reagent vial 10 will have a region defining a reduced cross-sectional area compared to the container portion 12 of reagent vial 10. This reduced cross sectional area will provide a well region 19 in the lower end of the vial 10, and depending from the container portion 12, into which liquid reagent will collect as the reagent supply in the container portion 12 becomes depleted. As such, the residual volume of the reagent will continue to concentrate into a smaller cross section, rendering the reagent more readily accessible to the means used to withdraw the reagent. The actual configuration of the cross section of this well region 19 is not considered to be critical, rectangular or curvilinear shapes will each prove acceptable. However, it is considered desirable that the lower-most floor portion of well region 19 be somewhat rounded, as depicted most clearly in FIGS. 1C and 2C, so that the last remaining volume of the liquid reagent be most concentrated in the region surrounding the tip of the probe which is used to withdraw the reagent.

The OptiMax® apparatus described previously utilizes a reagent pipette tip mounted on a mechanical reagent tip head to withdraw reagents from the storage vials. The tip head is adapted to pick up disposable plastic pipette tips from the standard containers in which such tips are supplied (for example, Catalog No. 3510-R from E&K Scientific Products, Saratoga, Calif.). These disposable pipette tips are currently sold in a rack which presents the base of the tip for insertion of a hand-held pipette body into the hollow tip, the tips being arranged in an array so that all individual tips in the container are accessible to the user. The attachment steps for attaching pipette tips to the tip head are generally carried out by a pre-selected movement of the arm of the apparatus, and the apparatus is programmed as appropriate for the individual slides being treated and reagent vials placed at their own predetermined locations. The tip head on the movable arm then picks up a disposable pipette tip from the pipette tip rack, is repositioned over the opening neck 14 of the reagent vial 10, and activated to take up a reagent to be applied to a slide or group of slides from the reagent vial in the reagent container holder. In such automated operations, it is considered desirable that the plurality of reagent vials each share a set of relatively uniform dimensions, such as overall size, depth, and position of the opening neck 14 on the upper surface 13 of the vial 10.

The opening neck 14 of the container portion 12 will be generally aligned with the lower end 18 well configuration, so that a elongate probe such as the aforementioned pipette tip and tip head, or a manual pipette device, inserted through the opening neck 14 and through the container portion 12 will be capable of accessing the well chamber 19 to the bottom-most extent. In the reagent vial depicted in this embodiment, the well chamber 19 is depicted as having a substantially elongate configuration, complementary to the typical shape of the aforementioned disposable pipette tips, so as to enhance the reagent-concentrating effect of the vial 10 as the reagent supply nears exhaustion.

The present reagent vial 10 will typically include a suitably-configured stopper plug 20, which is typically of a configuration to engage with the array of external threads 16 formed on opening neck 14. Such a stopper plug will aid in the transportation of liquid reagents contained in vial 10, as well as any necessary mixing or dilution of reagents prior to their use.

Turning to FIG. 2, the reagent vial of the present invention is depicted in an alternative embodiment includes a container portion 22 which is substantially smaller in total volume that the container portion 12 of the embodiment of FIG. 1. This embodiment is intended to contain substantially lower volumes of reagent, a feature deemed desirable for particularly costly reagents.

Although the general configuration and rectangular cross section of container portion 22 is similar to that portrayed in the embodiment of FIG. 1, the lower end well region 24 configuration is shown to be substantially elongated, when compared to well region 19 as depicted in the embodiment of FIG. 1. This is intended, in part, to maintain the depth parameter of the vial 10, as discussed previously. This feature will allow vials of substantially different volumes to be utilized in a single operation, for example to be positioned in the same reagent vial rack such as the aforementioned rack for the OptiMax® automated immunostainer apparatus.

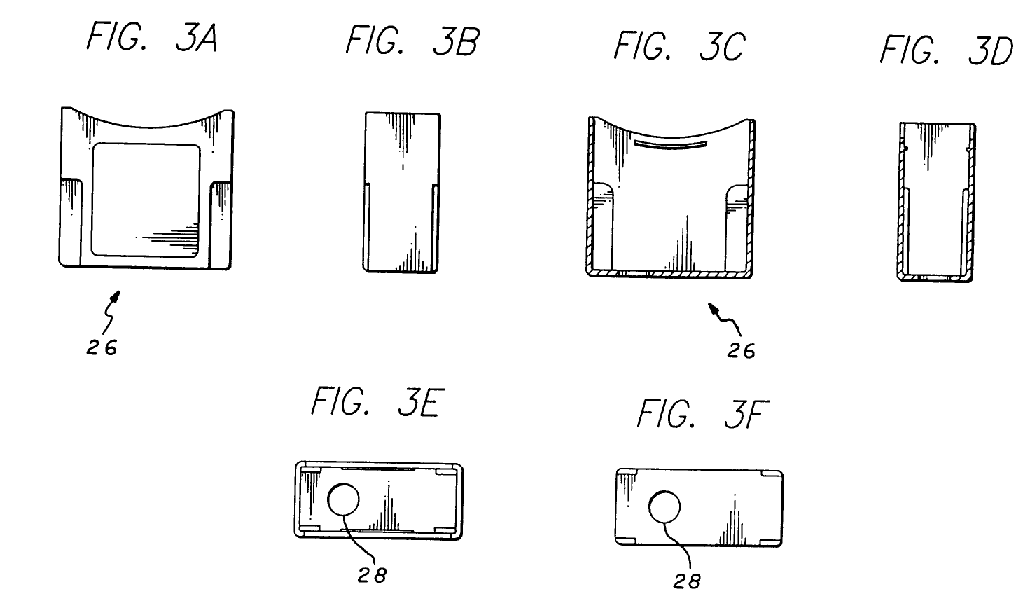

However, the use of the reagent vial embodiments of FIGS. 1 and 2, and particularly in view of the reduced size of the container portion 22 of the embodiment of FIG. 2, the placement and stability of the reagent vial in the rectangular receptacles of a vial rack may be problematic. Therefore, each of container portions 12 and 22 are adapted to be engaged with an adapter assembly 26 as depicted in FIG. 3. The adapter assembly 26 will typically also be constructed in accordance with known techniques, desirably blow molded or injection molded from a suitable plastic material, in a manner similar to the reagent vial 10.

Typically, the cross section of the adapter assembly will be complementary to the cross section of the reagent vial 10, or at least the container portion thereof, so as to provide a receptacle for releasably receiving the reagent vial and maintaining it in a substantially upright position. It may also be considered desirable to configure both the reagent vial 10 and the adapter assembly 26 to engage each other via a plurality of complementary configurations, or paired recesses and detents. For example, as depicted in FIG. 1, reagent vial 10 can be configured with a plurality of stepped shoulder regions, and adapter assembly 26 can be configured with a plurality of complementary stepped shoulder regions, as depicted in FIG. 3. Thus, the engagement between the reagent vial 10 and the adapter assembly 26 will comprise the horizontal positioning provided by the complementary cross sectional configurations and the vertical positioning provided by the complementary shoulder configurations.

The adapter assembly 26 will be configured to occupy the available space in the rack or other receptacle of the selected automated processing apparatus, and to provide a more secure and precise placement of reagent vial 10. The assembly 26 will also generally include a means for positively locating the well region of the vial, to provide reference orientation for the vial, and contribute to the stability of its positioning on the rack. Thus, FIG. 3 depicts adapter assembly 26 as including a orifice 28 which is selectively engageable with the well regions 14 and 24 of container portions 12 and 22. Such an orifice will provide the described positioning and stability benefits, as well as a means for allowing wash liquid to drain from the assembly during routine cleaning operations.

Thus, the present invention further provides a reagent vial adapter for use with the present reagent vial in automated processing devices comprising a receptacle portion configured to releasably receive and maintain the reagent vial in a substantially upright position, and a positioning means for positively locating the chamber of the reagent vial, and thereby maintaining said reagent vial in the desired location within the adapter.

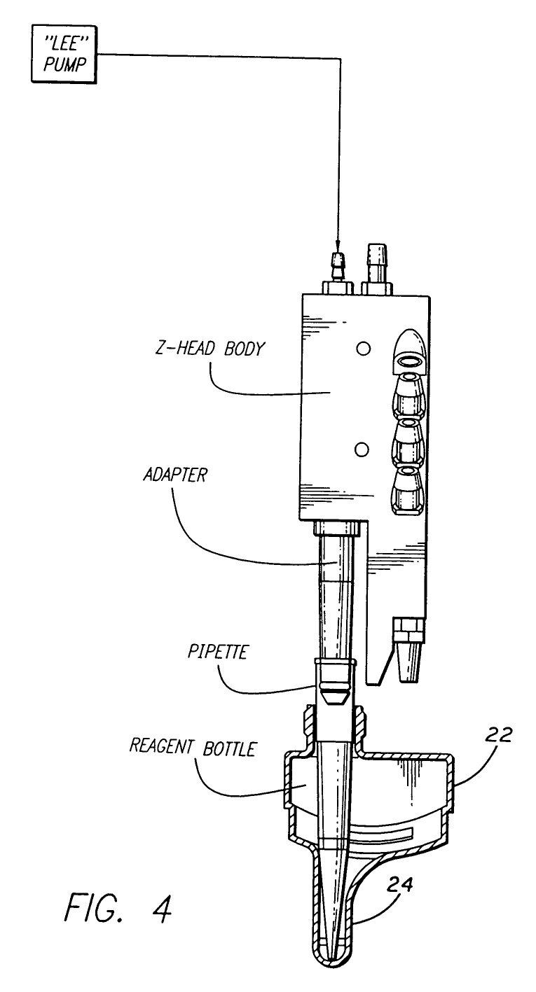

The present reagent vial 10, as depicted in FIGS. 1 and 2, with or without the adapter assembly 26 depicted in FIG. 3, is employed initially as shown in FIG. 4. In particular, a reagent vial 10 having a reagent stored therein is utilized by a clinical laboratory where, shortly prior to conducting an appropriate test or staining procedure, a laboratory technician will match a reagent vial with a reagent storage location in the automated processing apparatus preparatory for use in the procedures determined by the operator. As suggested previously, the reagent vial may be color coded to insure a proper match for a particular operation of the automated processing apparatus. Alternatively, the technician may add an appropriate reagent to an empty container and place the same into the appropriate location in the automated processing apparatus. Upon selection of the appropriate manipulation steps or instruction set preprogrammed into the automated processing apparatus, the probe of the apparatus will be programed to position itself above the opening neck of the present reagent vial and extend the probe into the reagent vial for access by the probe to the reagent contents therein. The iteration of this sequence of steps, the operation of the apparatus will allow successive aliquots of reagent to be withdrawn from the reagent vial until the supply is exhausted. By virtue of the utilization of the present reagent vial 10, the residual reagent in the vial which is inaccessible to the apparatus will be minimized.

All patents and patent applications cited in this specification are hereby incorporated by reference as if they had been specifically and individually indicated to be incorporated by reference.

Although the foregoing invention has been described in some detail by way of illustration and example for purposes of clarity and understanding, it will be apparent to those of ordinary skill in the art in light of the disclosure that certain changes and modifications may be made thereto without departing from the spirit or scope of the appended claims.

1. A reagent vial for use with automated processing devices which utilize elongate probes to withdraw reagents from vials comprising
a container portion configured to contain a volume of liquid reagent, said portion having an upper end and a lower end,
said upper end configured to provide means for access to the contents of the container portion by a probe used to withdraw a predetermined amount of the liquid contained therein,
said lower end configured to provide a chamber having a lesser cross sectional area than the container portion, said chamber configured to contain a portion of the volume of liquid reagent and aligned with the probe access means, thereby providing a means for accessing the liquid reagent contained in said chamber and reducing the residual volume of reagent which can not be withdrawn from said vial by said probe.

2. A reagent vial as recited in claim 1 wherein said chamber is unitarily formed with said container portion.

3. A reagent vial as recited in claim 1 wherein said container portion has a substantially rectangular horizontal cross section.

4. A reagent vial as recited in claim 1 wherein the chamber has a lower end of substantially hemispherical configuration.

5. A reagent vial as recited in claim 1 wherein said upper end is further configured to provide means for labeling said reagent vial with information which is perceptible when viewing the upper end of said vial.

6. A reagent vial adapter for use with a reagent vial in automated processing devices comprising
a receptacle portion configured to releasably receive and maintain in a substantially upright position a reagent vial having a container portion configured to contain a volume of liquid reagent, said container portion having an upper end and a lower end, said lower end configured to provide a chamber having a lesser cross sectional area than the container portion; and
a positioning means for positively locating said chamber of the reagent vial, and thereby maintaining said reagent vial in the desired location within the adapter.

7. A reagent vial adapter as recited in claim 6 wherein said receptacle portion has a substantially rectangular horizontal cross section.

8. A reagent vial adapter as recited in claim 6 wherein said adapter further comprises means for facilitating the removal of any liquid contained within said adapter.

9. A reagent vial adapter as recited in claim 6 wherein said positioning means comprises an orifice for receiving at least a portion of the chamber of the reagent vial.

10. A reagent vial adapter as recited in claim 6 wherein said receptacle portion is configured to receive and position said reagent vial in both horizontal and vertical dimensions.

11. A reagent vial system for facilitating use of a reagent vial in automated processing devices which utilize elongate probes to withdraw reagents from vials comprising
a reagent vial comprising
a container portion configured to contain a volume of liquid reagent, said portion having an upper end and a lower end,
said upper end configured to provide means for access to the contents of the container portion by a probe used to withdraw a predetermined amount of the liquid contained therein,
said lower end configured to provide a chamber having a lesser cross sectional area than the container portion, said chamber configured to contain a portion of the volume of liquid reagent and aligned with the probe access means, thereby providing a means for accessing the liquid reagent contained in said chamber and reducing the residual volume of reagent which can not be withdrawn from said vial by said probe; and
a reagent vial adapter for use with said reagent comprising
a receptacle portion configured to releasably receive and maintain in a substantially upright position said reagent vial by engaging the container portion thereof, and
a positioning means for positively locating the chamber of the reagent vial, and thereby maintaining said reagent vial in the desired location within the adapter.

12. A reagent vial system as recited in claim 11 wherein said container portion of said vial and said receptacle portion of said adapter have complementary substantially rectangular horizontal cross sections.

13. A reagent vial system as recited in claim 11 wherein said reagent vial and said adapter have complementary means to position said reagent vial in both horizontal and vertical dimensions in said adapter.
